(19) United States
(12) Patent Application Publication
(10) Pub. No.: US 2010/0181760 A1
(43) Pub. Date: Jul. 22, 2010

(54) SNAP-FIT FITTING FOR CORRUGATED STAINLESS STEEL TUBING

(75) Inventors: Scott Duquette, East Windsor, CT (US); Franz Kellar, Gastonia, NC (US); Harold Crowder, Concord, NC (US); Vanwijak Eowsakul, Holyoke, MA (US)

Correspondence Address: EDWARDS ANGELL PALMER & DODGE LLP, P.O. BOX 55874, BOSTON, MA, 02205, US

(73) Assignee: TITEFLEX CORPORATION, Springfield, MA (US)

(21) Appl. No.: 12/598,380

(22) PCT Filed: May 30, 2008
(86) PCT No.: PCT/US08/06858

§ 371 Date: Feb. 4, 2010

Related U.S. Application Data
(60) Provisional application No. 60/932,294, filed on May 30, 2007.

(51) Int. Cl. F16L 21/06; B23P 11/00

(52) U.S. Cl. 285/330; 29/525.02

(57) ABSTRACT

A fitting incorporating a snap-fit sealing and locking device and methods of actuating the fitting and forming a seal between a length of corrugated tubing and the fitting are provided. The tubing can be corrugated stainless steel tubing having a jacket that at least partially covers the tubing. The sealing and locking device incorporates a bushing that is advanced through the application of axial pressure into a sleeve portion. Fingers on the bushing engage one or more corrugation grooves on the tubing and apply force to the tubing to collapse one or more corrugations to form a metal-to-metal seal. Distal motion of the bushing is inhibited after forming a metal-to-metal seal by contact between the bushing and the sleeve portion.

### FIELD OF INVENTION

The present invention relates to gas and liquid piping systems, and more particularly to a fitting incorporating a sealing and locking device for forming a seal between a length of corrugated tubing and the fitting, the fitting being configured to snap in place over the length of corrugated tubing.

### BACKGROUND OF THE INVENTION

Gas and liquid piping systems which utilize corrugated stainless steel tubing (“CSST”) and fittings are known. Such piping systems can be designed for use in combination with elevated gas pressures of up to about 0.03 megapascals (MPa) or more, and provide advantages over traditional rigid black iron piping systems in terms of ease and speed of installation, elimination of onsite measuring, and reduction in the need for certain fittings such as elbows, tees, and couplings. Undesirably, some fittings conventionally used with CSST systems include fiber sealing gaskets or polymer O-rings which can deteriorate over time, or pre-flared tubing ends, which suffer from reliability problems.

A suitable self-aligning and self-flaring fitting assembly, which does not require the use of a sealing gasket, is disclosed in U.S. Pat. No. 6,173,995 to Mau (“the '995 patent”), which is incorporated by reference herein. The '995 patent is owned by Titeflex Corporation, assignee of the present application, and discloses a self-flaring fitting assembly for use with semi-flexible, convoluted tubes or pipes, including CSST systems. The fitting assembly includes an externally-threaded adapter having a pipe receiving bore divided into a plurality of sections of different diameters, a nut threaded to a first end of the adapter, and a split bushing assembly with at least two internally spaced ribs for engaging circumferential grooves of the corrugated tubing, as shown in FIGS. 2-5 of the '995 patent. The fitting assembly disclosed in the '995 patent forms a seal by compressing an end corrugation or convolution between an internal stop shoulder of the adapter and one end of the split bushing assembly. A seal formed according to the above mechanism may be suitable for preventing leaking of gas and/or liquid through the pipe and fitting connection. However, in some instances, excessive torque may be required to create a seal on certain types of tubing. It would also be desirable to generate a uniform force, per circumferential unit distance, sealing interface that can provide a known sealing pressure per unit area of corrugated sealing surface engaged.

Additionally, fittings incorporating a nut or other rotational devices for forming a seal require the use of a tool such as a wrench to advance the nut. In addition to the difficulties caused by the large amounts of torque that are often required to form a seal, such a fitting may be difficult or impossible to install in tight spaces. In particular, where a fitting is connected to a multi-port manifold, an installer may have a limited angle in which to move a wrench. In other situations, insufficient space may be available for the use of a wrench of sufficient length to deliver the required torque. For these reasons, a fitting that does not require rotational force to form a seal is desirable.

It would be desirable to provide a fitting having a suitable sealing mechanism for connecting the fitting to a length of tubing. Such a fitting preferably could be adapted for use with different types of tubing and fitting interfaces and other piping and tubing systems, particularly those designed for transporting gas and/or liquid.

Further, it would be desirable to provide an improved fitting configured for connection to a length of corrugated tubing, where the fitting incorporates a quick actuating sealing and locking device. The fitting and related devices and methods should overcome the deficiencies of the presently available fittings and sealing arrangements, for which it can be difficult to produce a suitable amount of torque, and in which a suitable circumferential sealing force per unit area has not heretofore been achieved.

### SUMMARY OF THE INVENTION

A fitting incorporating a snap-fit sealing and locking device for corrugated stainless steel tubing is disclosed, where the sealing and locking device is incorporated into a fitting for connecting a length of corrugated stainless steel tubing to the fitting. The sealing and locking device can form a seal without requiring rotational force, which enables installation in confined spaces where use of a wrench may not be practical or feasible.

According to the present invention, a sealing device for connecting a length of corrugated tubing is exemplified by a bushing received in the fitting. The bushing engages one or more corrugation grooves of the tubing and advances the tubing to collapse one or more corrugations against a portion of the fitting, for example an adapter, to form a metal-to-metal seal. The fitting has a sleeve portion for receiving the tubing and guiding the bushing as the tubing and bushing advance in an axial direction. The bushing can be advanced by application of axial force, and distal motion of the bushing is inhibited after forming the metal-to-metal seal by contact between the bushing and the sleeve portion.

The sealing device can have different configurations and be formed of various materials according to the present invention. For example, the bushing can include a plurality of fingers on a sealing end. The fingers of the bushing can be formed in various shapes, such as: triangular, angular, looped, folded, circular, conical, elliptical, and a specific geometry of the sleeve portion. The bushing is configured to receive an axial load for sealing, the bushing having at least one of: a flange, a tab, a formed feature, and a ring and fold.

Distal motion of the bushing can be inhibited after forming the metal-to-metal seal by friction between the bushing and the sleeve portion. Additionally or alternatively, the bushing and/or the sleeve member can include one or more geometries for inhibiting distal motion of the bushing in the sleeve portion selected from the group including: holes, dimples, tabs, locking devices, and flanges.

The bushing can be formed as a single piece, e.g., by metal injection molding. The bushing may be substantially continuous circumferentially, or alternatively may be a split bushing. In some embodiments, the bushing elastically deforms at a defined load rating. The bushing may be formed from at least one of a metal, metal alloy, plastic, polymer, and elastomer. In some embodiments, the sleeve portion is shaped to facilitate advancement of the bushing and engagement of the fingers.

In other embodiments, the length of tubing is covered by a jacket, the bushing terminates in a second plurality of fingers, and the second fingers engage the jacket. In further embodiments, the second fingers reduce stress on a portion of the tubing between the region in which the second fingers engage with the jacket and the one or more collapsed corrugations.

In some embodiments, the fitting further includes an adapter configured to receive the sleeve portion. The adapter and the sleeve member may form a single, unitary component. In other embodiments, the metal-to-metal seal is an annular sealing contact ring.

In certain embodiments, the sleeve portion limits the amount of force that can be applied to the bushing and the one or more corrugations. The fitting in some embodiments includes a stop shoulder to center the tubing when forming the metal-to-metal seal. Additionally or alternatively, the fitting may include one or more ridges on a sealing face.

A method for forming a seal between a length of corrugated tubing and a fitting can include steps of: providing the fitting with a sleeve portion for receiving the tubing, providing a bushing configured to engage one or more corrugation grooves of the tubing, the bushing being received in the sleeve portion, advancing the tubing and the bushing axially by application of axial force to form a metal-to-metal seal, and inhibiting the bushing from further distal motion by contact between the bushing and the sleeve portion.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIGS. 1(a) to 1(c) are cross-sectional views depicting a length of corrugated tubing received in a fitting, which incorporates a snap-fit sealing and locking device, according to a first preferred embodiment of the present invention;

FIG. 2 is an enlarged cross-sectional view depicting a portion of the tubing and fitting shown in FIG. 1(c);

FIG. 3 is a perspective view depicting a length of corrugated tubing received in a fitting, which incorporates the snap-fit sealing and locking device of FIGS. 1(a)-1(c) and 2;

FIGS. 4(a) to 4(c) are various views of a bushing configured with several locking devices according to a second preferred embodiment of the present invention;

FIG. 5 is a cross-sectional view incorporating the bushing shown in FIGS. 4(a) to 4(c) used with a fitting and a locking device;

FIGS. 6(a) and 6(b) are cross-sectional views of a seal formed by semi-smooth bore tube received in a fitting having a stop shoulder according to a third preferred embodiment;

FIGS. 7(a) and 7(b) are cross-sectional views of a seal formed by semi-smooth bore tube received in a fitting having a stop shoulder and a plurality of ridges according to a fourth preferred embodiment;

FIGS. 8(a) to 8(b) are views of a fitting having a retention member for interacting with a flanged locking device according to a fifth preferred embodiment; and

FIG. 9 is a cross sectional view of alternative designs of fingers for an exemplary bushing.

### DEFINITIONS

The instant invention is most clearly understood with reference to the following definitions:

As used in the specification and claims, the singular form “a”, “an” and “the” include plural references unless the context clearly dictates otherwise.

As used herein, the terms “corrugated stainless steel tubing” and “CSST” refer to any type of semi-flexible tubing or piping, which may accommodate corrosive or aggressive gases or liquids, and includes but is not limited to semi-flexible tubing or piping made from: thermoplastics, metal or metal alloy materials such as olefin-based plastics (e.g., polyethylene (PE)), fluorocarbon polymers (e.g., polytetrafluoroethylene (PTFE)), carbon steel, copper, brass, aluminum, titanium, nickel, and alloys thereof.

### DETAILED DESCRIPTION OF THE INVENTION

A fitting incorporating a snap-fit sealing and locking device for forming a seal between a length of corrugated tubing and the fitting, and methods of actuating the fitting and forming a seal using the fitting and tubing are disclosed. The tubing can be corrugated stainless steel tubing (CSST) commonly used in gas and liquid piping systems. The tubing can be at least partially covered with a jacket. According to the present invention, a suitable seal can be formed without requiring excessive torque to form the seal.

A fitting according to the present invention includes at least an adapter having a sleeve portion and a bushing. The sleeve portion and adapter can be formed as a single piece, or the sleeve portion can be attached to the adapter during manufacturing, for example, by using any of a number of common techniques, in order to form a fluid tight seal between the sleeve portion and the adapter. For example, the sleeve portion can be affixed to the adapter by crimping, or the sleeve portion can be press fit to the outer diameter of the adapter. Further suitable techniques for connecting the sleeve portion and the adapter include brazing and welding. Additionally or alternatively, a compound such as a resin, adhesive, or epoxy can be applied to an interface between the sleeve portion and the adapter to form a suitable bond. Optionally, the interface between the sleeve portion and adapter can include an O-ring, gasket, or other elastomeric material.

Preferably, the adapter is affixed to a first or proximal end of the sleeve portion, where a second or distal end of the sleeve portion is configured to receive the tubing. As used herein, the proximal end of the sleeve portion refers to that end closest to the adapter, whereas the distal end of the sleeve portion refers to that end farthest from the adapter. Tubing can be received in the distal end of the fitting.

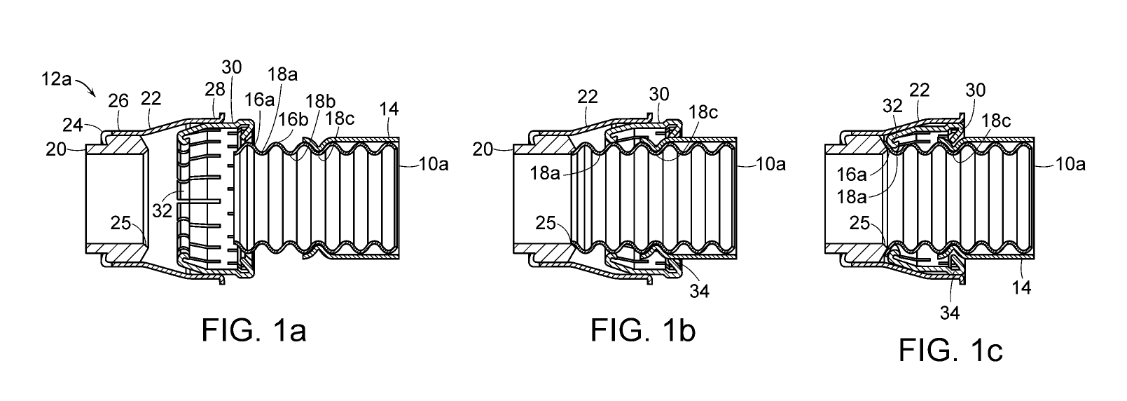

Referring to FIG. 1a, a length of corrugated tubing 10a can be received in a fitting 12a. The tubing 10a can be corrugated stainless steel tubing (CSST) commonly used for transporting gas and liquid. Preferably, the tubing 10a is at least partially covered by a jacket 14 made of any suitable material, for example, polyethylene. In certain embodiments, the jacket 14 can be peeled back from an end of the tubing 10a, thereby exposing one or more corrugations 16a, 16b of the tubing 10a. The tubing contains a number of corrugations 16a, 16b and corrugation grooves 18a, 18b, 18c.

The fitting 12a preferably includes at least an adapter (or body member) 20 and a sleeve portion 22. FIG. 1a depicts a fitting in which the sleeve portion 22 is attached to the adapter 20 using a crimp 24. However, the adapter 20 and the sleeve portion 22 can be formed as one piece or attached in any suitable manner, for example, by press fitting, bonding, brazing, or welding, and preferably prior to inserting the tubing 10a and jacket 14 into the fitting 12a. The adapter 20 preferably has a sealing cone 25 where the tubing 10a contacts the adapter 20. The adapter 20 preferably is configured with an appropriate geometry to facilitate receiving and mating with a bushing 30. For example, the geometry may be produced using a variety of techniques including machining and casting. In some embodiments, the adapter 20 may include a bushing mating surface configured to receive the bushing 30.

The sleeve portion 22 preferably is made of metal or a metal alloy, but can be made of other formable materials such as plastics, polymers, or elastomers. The sleeve portion 22 has a proximal end 26 and a distal end 28, the proximal end 26 being located near or adjacent to a connection between the adapter 20 and the sleeve portion 22 and the distal end 28 being located away from the adapter/sleeve portion interface.

The sleeve portion 22 is configured to receive the bushing 30. The bushing 30 includes a plurality of fingers 32 (or a “first plurality of fingers”) which engage at least one corrugation groove 18a when the bushing is advanced proximally. The fingers 32 include ends that preferably engage and/or lock on one or more corrugation grooves of the tubing. The bushing 30 may contain one or more tab slots (not shown) that engage tabs (not shown) on the interior of the sleeve portion 22 to lock the bushing 30 into place when advanced proximally into the sleeve portion 30. Additionally or alternatively, the bushing 30 may be retained by friction between the bushing 30 and the sleeve portion 22.

The bushing 30 preferably is configured to receive the corrugation 16 of the tubing 10a and has sufficient strength to collapse the tubing 10a. The bushing 30 also should have sufficient stiffness to press the corrugation 16 while being deflectable to account for manufacturing variances. The bushing 30 preferably can apply a sufficient axial load to the tubing 10a without buckling. The fingers 32 or corrugation contact geometry should close together to form a near complete ring around the tube corrugation to ensure sealing reliability.

The bushing 30 may be composed of any formable material including, but not limited to: metal, alloy, plastic, polymer and/or elastomer. The bushing 30 may be formed from one piece or multiple pieces of sheet stock. Alternatively, the bushing 30 may be formed through metal injection molding. The bushing may include two or more segments that may be joined by a tack weld or retaining component such as a wire or spring.

In some embodiments, the bushing 30 has a compliant nature in which the bushing elastically buckles and/or deforms once a specified load factor is achieved. This prevents damage to the seal and/or the tubing 10a from excessive force. This feature also results in a bushing 30 that has a low sensitivity to manufacturing geometry variations.

The fingers 32 preferably have an internal geometry that is somewhat circular. Various geometries, including geometries such as angular, triangular, circular, elliptical as well as geometries that closely minor the shape of the corrugation grooves 18a, may be advantageous with various sizes of tubing 10a. Additionally, certain geometries, materials, and thicknesses can be selected for the tubing 10a based on the desired shape of the collapsed corrugation(s) 16a.

In some embodiments, the fingers 32 preferably have an external geometry that interacts with the internal geometry of the sleeve portion 22 to facilitate closing of the fingers 32 and engagement of the fingers 32 with the one or more corrugation grooves 18a. For example, the external geometry of the fingers 32 may be conical, angular, or a similar geometry to the internal geometry of the sleeve portion 22.

The sleeve portion 22 may also be modified to adopt any necessary configuration such as a termination fitting. In particular, the sleeve portion may include male threads for engaging a termination fitting.

Referring now to FIG. 1b, the tubing 10a is advanced proximally into the sleeve portion 22 and the bushing 30 until the tubing 10a contacts the adapter 20.

Referring now to FIG. 1c, the bushing 30 is advanced proximally into the sleeve portion 22. The bushing 30 may be advanced with a standard or specialized hand tool that engages the bushing 30 and advances it to a retained position. As the bushing 30 advances, the geometry of the sleeve portion 22 interacts with the geometry of the bushing 32, causing the fingers 32 to engage one or more corrugation grooves 18a. The fingers 32, now engaged, exert axial force on the tubing 10a, crushing one or more corrugations 16a, 16b to be crushed against the adapter 20 and uniformly applying a load to the one or more crushed corrugations 16a, 16b to form a gas and liquid tight seal.

The bushing 30 is held in place, i.e., distal motion of the bushing is inhibited, after the formation of the metal-to-metal seal by contact between the bushing 30 and the sleeve portion 22. In one embodiment, friction between the bushing 30 and sleeve portion 22 substantially can hold the bushing 30 in place. Frictional forces may be enhanced through the selection of metals with low coefficients of friction, applying a friction increasing coating to the bushing 30 and/or the sleeve portion 22, and/or machining the bushing 30 and/or the sleeve portion 22 to produce a rougher surface. In another embodiment, an adhesive or epoxy may be applied to the bushing 30 before it is driven into the sleeve member 22. In a further embodiment, the bushing is held in place through the use of geometries on the bushing 30 and/or the sleeve portion 22 as described herein.

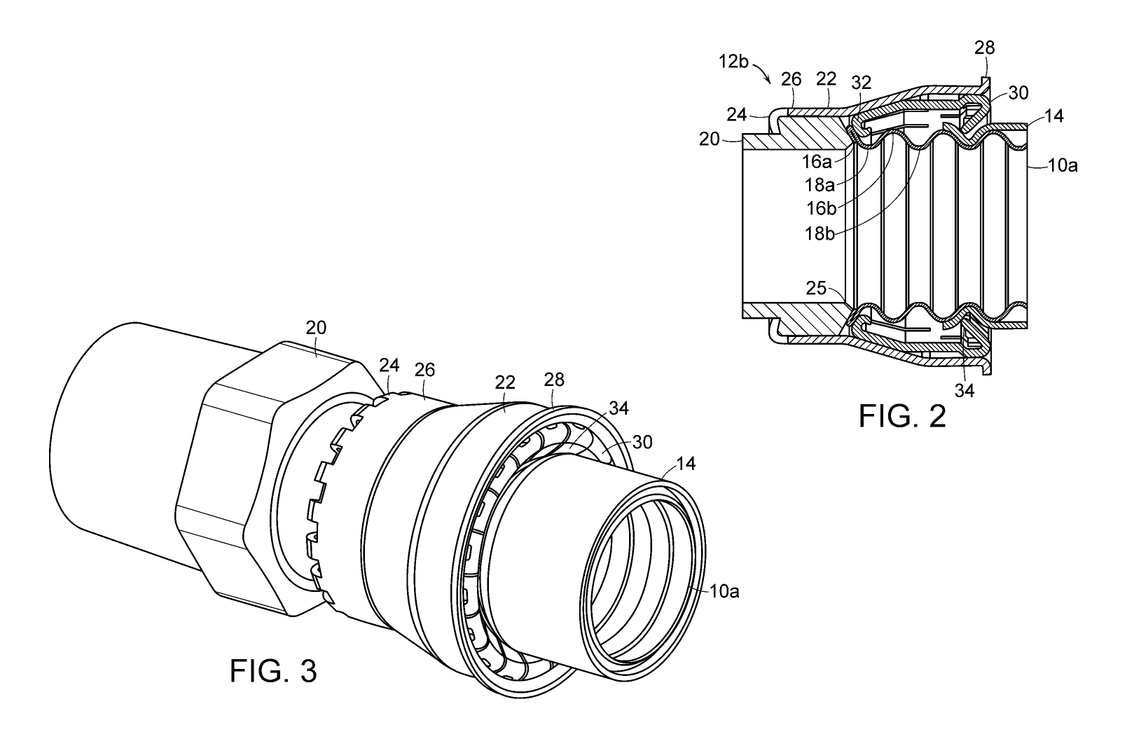

In some embodiments, the distal end of the bushing 30 contains a second plurality of fingers, also referred to herein as jacket-engaging fingers 34. The jacket-engaging fingers 34 preferable engage a portion of the jacket 14 in the area of at least one corrugation groove (see, e.g., FIGS. 2-3). The jacket-engaging fingers 34 are advantageous in at least two respects.

First, the jacket-engaging fingers 34 can increase jacket 14 retention. The jacket 14 protects the tubing 10a from potentially corrosive environments. Therefore, if the jacket 14 were to withdraw from the fitting 12, e.g., due to shrinkage, changes in temperature, vibration, etc., a portion of the tubing 10a could become compromised over time.

Second, the jacket-engaging fingers 34 may reduce stress on a portion of the tubing 10a between the region in which the fingers 34 engage the jacket 14 and the one or more collapsed corrugations, including the endmost corrugation 16a and optionally the corrugation 16b. During events such as installation or calamities such an earthquake, force may be exerted in the tubing 10a, pulling the tubing 10a distally from the fitting 12. While the seal formed by the one or more corrugations 16a, 16b should in all cases be capable of withstanding this force, the jacket-engaging fingers 34 provide an additional layer of support by absorbing stress and transferring the stress to the entire bushing 30. Such support also may reduce vibrations and other forces that could potentially cause the tubing 10a to suffer from metal fatigue.

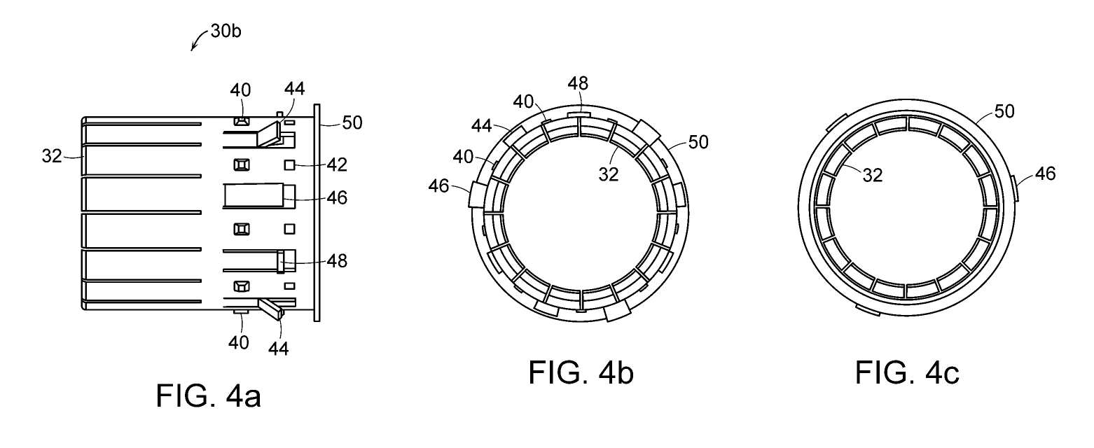

Referring to FIGS. 4(a)-4(c), a second preferred embodiment of a bushing is depicted (i.e., the bushing 30b). As in FIG. 1, the bushing 30b has a first plurality of fingers 32. However, the bushing 30b in FIGS. 4(a)-4(c) can include one or more elements not shown in the bushing 30 in FIG. 1. These elements are labeled with reference numbers 40, 42, 46, and 48, and some of these elements are redundant, and thus not required in every bushing 30b produced according to the second preferred embodiment. For example, the following components perform similar functions: elements 40 and 48, and elements 42 and 44, and thus it is not necessary to include the element 48 if the element 40 is already present, and likewise it is not necessary to include the element 44 if the element 42 is already present.

The bushing 30b can include a plurality of external and internal dimples 40 and 42, respectively. The external dimples 40 can interact with corresponding areas of the sleeve portion 22 of a fitting 12 to hold the bushing 30b in place before and during insertion of the tubing 10 through the bushing. The external dimples 40 preferably are overcome as the bushing 30b is driven into the fitting 12. In some embodiments, the external dimples may act to inhibit distal movement of the bushing 30b in the sleeve portion 22. The internal dimples 42 protrude into the bushing 30b, such that the dimples 42 engage and hold the tubing in place, and thus may inhibit movement of the tubing 10 and/or jacket 14.

The bushing 30b also contains several locking devices 44, 46, and 48. The locking devices 44, 46, and 48 can be tabs of various designs, which are designed to flex towards the center of the bushing 30b as the bushing 30b is driven into the fitting 12. Once the bushing 30b advances to a certain point, the internal geometry of the fitting 12 allows the locking devices 44, 46, and 48 to return to their normal position. In this normal position, the locking devices 44, 46, and 48 engage the fitting 12 to inhibit distal movement by the bushing 30b. The locking devices 44, 46, and 48 may also be used to hold the bushing 30b in place between manufacture and installation.

In particular, the locking device 44 preferably is an axial locking device having a portion generally congruent with the bushing and an angled portion. The locking device 44 preferably can be compressed such that a portion of the device 44 contacts the jacket 14 so as to serve as a jacket locking device, and thereby prevent the jacket 14 from withdrawing from the bushing. In the locking device 46, the entire tab 46 is angled from the bushing 30b.

The locking device 48 also has a portion generally congruent with the bushing 30b and an angled portion. In some embodiments, the angled portion of locking device 48 may be approximately 90 degrees. The locking device 48 has a function similar to the external dimples 40, and thus it is possible to omit one of these elements.

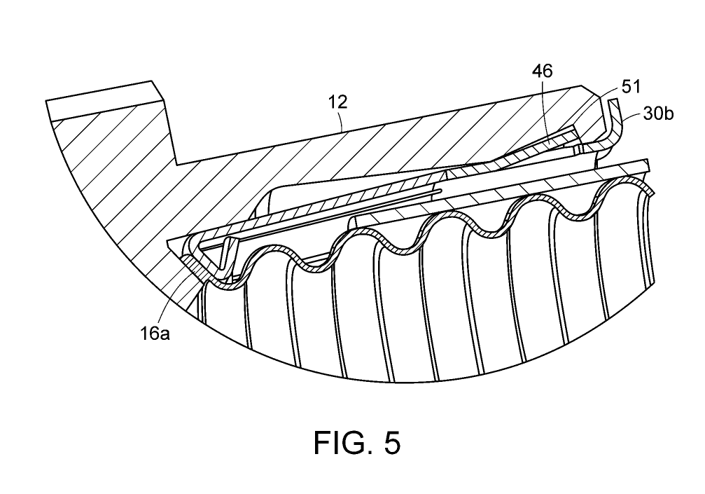

The interaction of the locking device 46 with the fitting 12 is depicted in FIG. 5. The bushing 30b has been driven proximally to collapse one or more corrugations 16a, 16b. As the bushing 30b is driven axially, the locking device 46 expands to interact with a groove 51. The groove 51 may be any feature suitable to interact with a locking feature 44, 46, or 48. While a recess is shown in FIG. 5, the groove 51 may be a ridge or other protuberance. The groove 51 may be produced by casting, machining, welding, or any other method known to those of skill in the art. While the locking device 46 is depicted in FIG. 5, the principles illustrated are applicable to the locking devices 44 and 48.

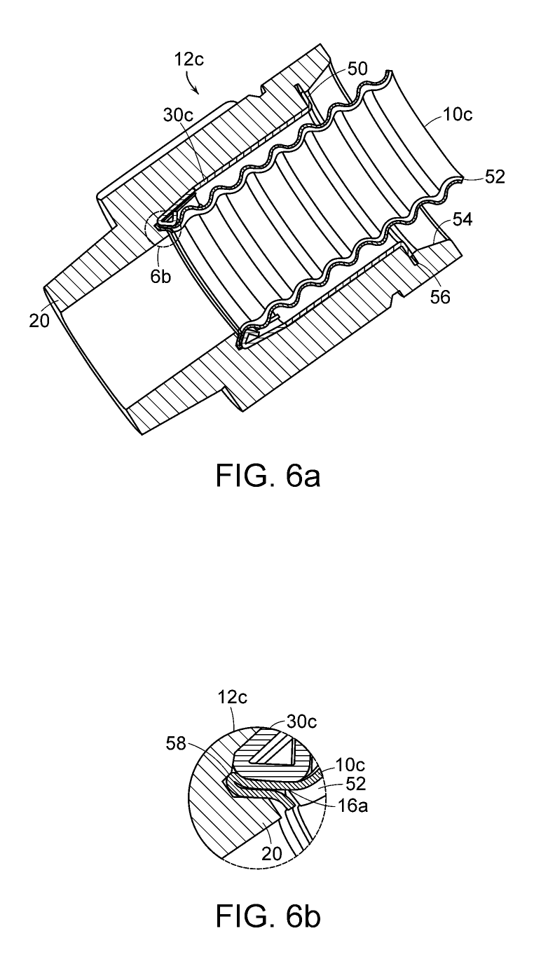

A rim or flange 50 is depicted in FIGS. 4(a)-4(c) and 6(a)-6(b). The operation of the rim 50 can be understood with reference to FIG. 6(a). FIG. 6(a) shows a fitting 12c coupled with a length of tubing 10c. While the fitting 12c is a one-piece fitting, unlike the fittings 12a and 12b, the fitting 12c operates according to the same general principles as the fittings 12a and 12b. Tubing 10c preferably is semi-smooth bore tubing. Smooth bore and semi-smooth bore tubing contain a filler or liner material 52 which creates a smooth or semi-smooth bore inside the tubing 10c.

The filler or liner material 52 may be any flexible or semi-flexible material including, but not limited to, polymers and/or resins. In some embodiments, the filler or liner material 52 may have properties such as corrosion resistance and/or flame resistance/retardation. In additional embodiments, the filler or liner material 52 may provide insulation against sound, temperature, and/or vibration. However, the filler or liner material 52 need not necessarily have sound insulating properties to reduce the sound produced by an unlined or unfilled tube. Rather, many filler or liner materials 52 will exhibit less resonance than unlined metal tubing such as the tubing 10a and 10b, and therefore produce less sound when fluid flows through the tubing 10c incorporating the filler or liner material 52.

The fitting 12c is configured to receive a bushing 30c, which includes the rim 50. As the bushing 30c is driven proximally into the fitting 12c, the rim 50 interacts with a tapered region 54 of the fitting 12c. The tapered nature of the fitting creates pressure causing the bushing 30c to compress and/or deform, the rim 50 to compress and/or deform, and/or the fitting 12c to compress and/or deform. As the bushing 30c continues to be proximally driven into the fitting 12c, the rim 50 reaches a recess 56 on the interior of the fitting 12c. At this point, the bushing 30c, the rim 50, and/or the fitting 12c return to normal size and the rim 50 rests in the recess 56, holding the bushing 30c in place.

The inside bore of fitting 12c may also be wider where the fingers 32 engage the length of tubing 10a to allow for expansion of the fingers 32 when the corrugation(s) 16 of the tubing 10a are inserted. The inside bore of fitting 12c may also be wider where the seal is formed to allow the fingers 32 to slightly deform to ensure secure and adequate sealing face loading.

All of the locking devices 44, 46, and 48 can be formed through casting or injection molding. The locking devices 44, 46, and 48 optionally may be further formed by tooling or machining after casting or molding of the bushing 30b. Alternatively, the locking devices 44, 46, and 48 may be added to the bushing 30b through means such as a tack weld, adhesive, or epoxy.

Referring now to FIG. 6(b), the fitting 12c also includes a stop shoulder 58. The stop shoulder 58 generally centers the seal formed by the one or more collapsed corrugations 16a, resulting in a more reliable seal. Preferably, the stop shoulder extends 360 degrees around the adapter 20.

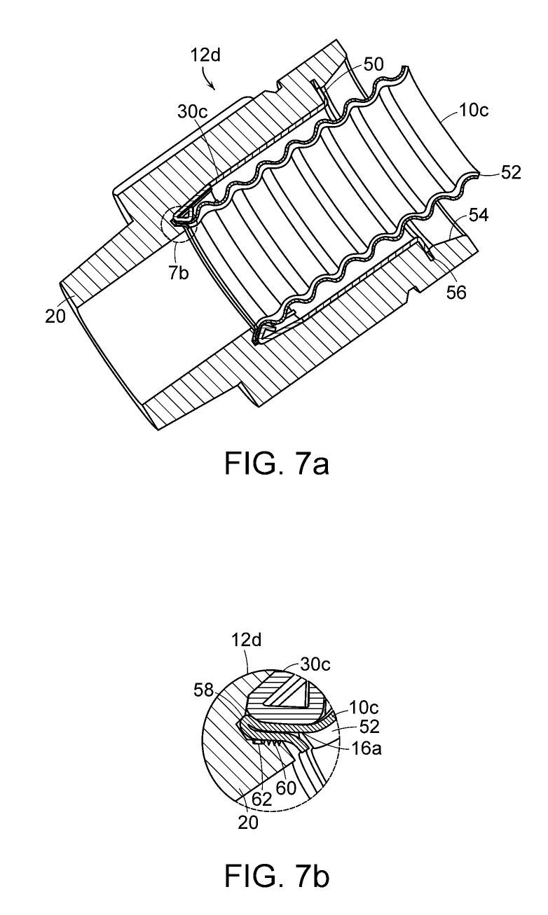

Referring now to FIGS. 7(a) and 7(b), a fitting 12d is provided. The bushing 30c and the tubing 10c in FIGS. 7(a) and 7(b) are similar to corresponding parts in FIGS. 6(a) and 6(b) and like numbers are used accordingly. The difference between FIGS. 7(a) and 7(b), as compared to FIGS. 6(a) and 6(b), is the addition of one or more ridges 60 and 62 on the sealing face of the adapter 20.

Use of a plurality of ridges 60 and 62 forming a ridge-like geometry in the metal-to-metal seal can provide significant advantages over conventional sealing techniques, which utilize generally flat or smooth sealing surfaces. For example, the sealing ridges 60 and 62 tend to form a more robust seal by presenting a feature, i.e., the ridge 60 and/or 62, which creates concentrated annular stress and/or deformation ring(s) with at least some overall tolerance for misalignment or component manufacturing variances, thereby avoiding durability and reliability problems that plague conventional fittings.

The ridges 60 and 62 can be provided in various shapes and sizes, and with different types of faces. Various shapes can be selected depending on particular applications, such as V-shaped peaks and valleys, U-shaped peaks and valleys, mixed U and V-shaped peaks and valleys, curved peaks and valleys, and non-uniform or different peak and valley shapes, such as flat shapes, arcs, and curves. The sealing face geometry can be chosen based on a particular application, and can include a conical shape, a flat face, or a curved face.

The spacing between the ridges 60 and 62 can be determined in a manner to optimize localized stress concentrations, and to achieve a design that forms an optimal seal when collapsing at least one corrugation. The ridges can be made of the material used for the adapter 20, such as stainless steel, or can be made of other materials such as brass and various plastics.

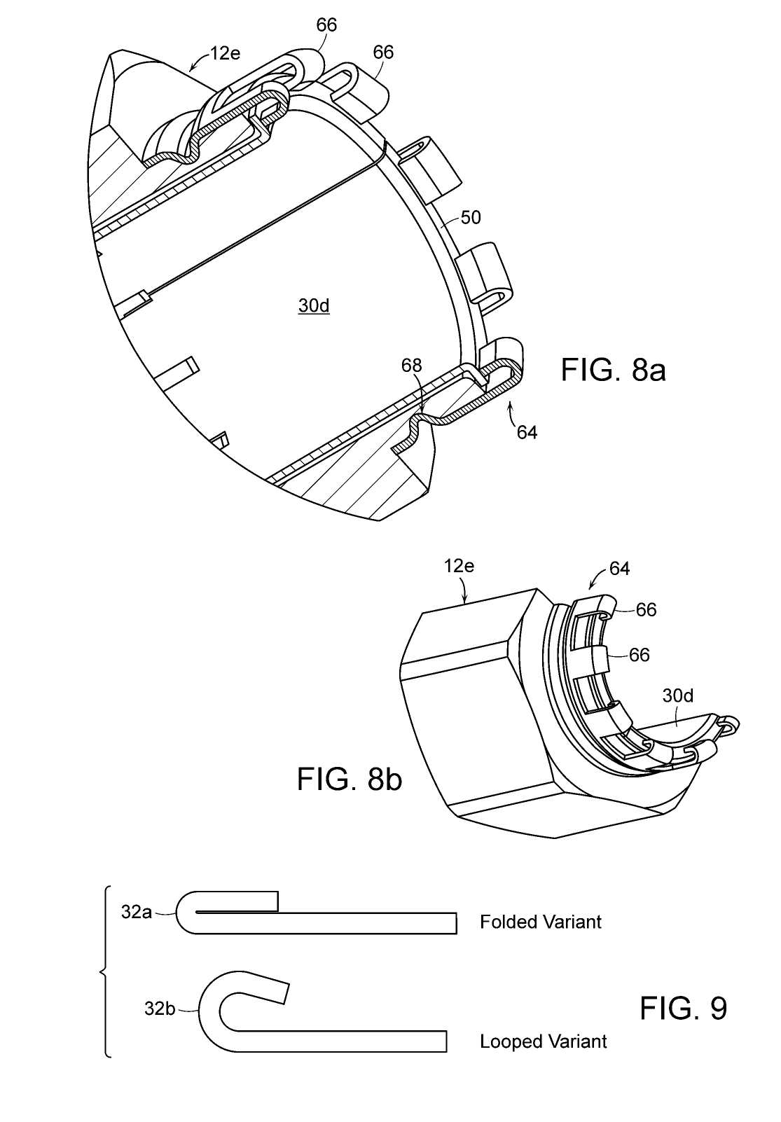

FIGS. 8(a) and 8(b) depict two additional features of fittings provided according to the present invention, a retention member and the combination of multiple locking devices. First, FIG. 8(a) shows that the use of the rim or flange 50 allows a bushing 30d to be used with a variety of different adapters 12. The sleeve member 22 of an adapter 12e includes a retention member 64 which interacts with the rim or flange 50. As shown in FIGS. 8(a) and 8(b), the retention member 64 preferably includes a plurality of fingers 66 (or a “third plurality of fingers”) to inhibit axial motion of the bushing 30d once a seal is formed. The fingers 66 may be looped as depicted in FIGS. 8(a) and 8(b). Alternatively, fingers 66 may include a bend or other geometry. The retention member 64 may also have a continuous or semi-continuous fold to form a groove similar to the groove 56 in FIGS. 6 and 7.

The retention member 64 may be attached to the fitting 12e by a variety of methods. As depicted in FIGS. 8(a) and 8(b), the retention member 64 may be crimped. To facilitate crimping, the adapter 12e may include a groove 68 (see FIG. 8(a)). Additionally or alternatively, the retention member 64 may be attached by threading, welding, tack welding, press fitting, adhesive, epoxies, fasteners, and other techniques known to those of skill in the art. As discussed herein, during insertion, the retention member 64 and/or the bushing 30d may deform as the bushing is driven axially.

Referring to FIG. 9, the fingers 32 useful as the second plurality of fingers may have a variety of geometries. For example, the fingers 32, as shown in FIG. 1, exhibit a triangular shape. Other fingers 32 may have an angular bend, for example, about 90 degrees. A finger 32a depicted in FIG. 9 has a folded geometry, whereas a finger 32b has a looped geometry. Each of the finger geometries depicted and/or described may be oriented inwardly or outwardly. Various geometries may be employed to form seals of various characteristics and may be selected to reflect characteristics of the fitting including: adapter size, shape, and or material; the presence and characteristics of a stop shoulder; and the presence, shape, and location of ridges. Finger geometries may also be affected by characteristics of the bushing and the tubing including but not limited to material, size, corrugation geometry, and presence of liner/filler material.

The present invention also encompasses methods for transporting gas and liquid through piping or tubing, in which at least a length of tubing is sealed to a fitting. The systems and methods can include transporting the gas, liquid, and/or slurry to or from a device, such as a boiler, furnace, stove, plumbing fixture, or sewerage system. The systems and methods also apply to water transport, chemical transport, and compressed air and other gas delivery systems.

The present invention further encompasses a method for installing a piping or tubing system in a structure, such as a commercial or residential building, where the installation method includes installing at least a length of tubing that is sealed to a fitting in the manner provided above. For example, the piping or tubing system can utilize CSST tubing and fittings.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A sealing device for connecting a length of corrugated tubing to a fitting, comprising:
a bushing that engages one or more corrugation grooves of the tubing and collapses one or more corrugations of the tubing to form a metal-to-metal seal; and
the fitting having a sleeve portion for receiving the tubing and the bushing as the tubing and the bushing advance axially by application of axial force, wherein the bushing is inhibited from further distal motion by contact between the bushing and the sleeve portion.

2. The sealing device of claim 1, wherein the bushing includes a plurality of fingers on a sealing end.

3. The sealing device of claim 2, wherein the fingers of the bushing are configured to compress the one or more corrugations against the fitting.

4. The sealing device of claim 3, wherein the fingers are formed in a shape selected from the group consisting of: triangular, angular, looped, folded, circular, conical, elliptical, and a specific geometry of the sleeve portion.

5. The sealing device of claim 1, wherein the further distal motion of the bushing is inhibited by friction between the bushing and the sleeve portion after the metal-to-metal seal is formed.

6. The sealing device of claim 1, wherein the bushing is configured to receive an axial load for sealing, the bushing having at least one of: a flange, a tab, a formed feature, and a dimple.

7. The sealing device of claim 1, wherein the bushing is formed with at least one locking device for engaging with the sleeve portion.

8. The sealing device of claim 1, wherein the sleeve portion is formed with at least one locking device for engaging with the bushing.

9. The sealing device of claim 1, wherein the bushing is circumferentially continuous.

10. The sealing device of claim 1, wherein the bushing is a split bushing.

11. The sealing device of claim 1, wherein the bushing is formed from at least one of the following materials: metal, metal alloy, plastic, polymer, and elastomer.

12. The sealing device of claim 1, wherein the tubing is covered by a jacket, the bushing terminates in a second plurality of fingers, and the second fingers engage the jacket.

13. The sealing device of claim 12, wherein the second plurality of fingers reduce stress on a portion of the tubing between where the second fingers engage with the jacket and the one or more collapsed corrugations.

14. The sealing device of claim 1, wherein the sleeve portion includes a retention member having a third plurality of fingers, the third plurality of fingers configured to engage a portion of the bushing.

15. The sealing device of claim 1, wherein the fitting further includes an adapter, and the adapter is configured to receive the sleeve portion.

16. The sealing device of claim 15, wherein the adapter and the sleeve member form a unitary component.

17. The sealing device of claim 1, wherein the metal-to-metal seal is an annular sealing contact ring.

18. The sealing device of claim 1, wherein the fitting is formed with a stop shoulder to center the tubing when forming the metal-to-metal seal.

19. The sealing device of claim 1, wherein the fitting includes a stop shoulder to center the tubing when forming the metal-to-metal seal.

20. The sealing device of claim 1, wherein the fitting includes one or more ridges on a sealing face.

21. A method for forming a seal between a length of corrugated tubing and a fitting, comprising the steps of:
providing the fitting with a sleeve portion for receiving the tubing;
providing a bushing configured to engage one or more corrugation grooves of the tubing, the bushing being received in the sleeve portion;
advancing the tubing and the bushing axially by application of axial force to form a metal-to-metal seal; and
inhibiting the bushing from further distal motion by contact between the bushing and the sleeve portion.

22. The method of claim 21, wherein the bushing includes a plurality of fingers on a sealing end, the fingers configured to engage the sleeve portion to form the metal-to-metal seal.

23. The method of claim 21, wherein the bushing is inhibited from further distal motion due to frictional contact between the bushing and the sleeve portion.

24. The method of claim 21, wherein the tubing is covered by a jacket, the bushing terminates in a second plurality of fingers, and the second fingers engage the jacket.

25. The method of claim 21, wherein the sleeve portion includes a retention member having a third plurality of fingers, the third plurality of fingers configured to engage a portion of the bushing.
